(19) United States
(12) Patent Application Publication
(10) Pub. No.: US 2025/0115302 A1
(43) Pub. Date: Apr. 10, 2025

(54) ROOF STRUCTURE FOR VEHICLE

(71) Applicants: Hyundai Motor Company, Seoul (KR); Kia Corporation, Seoul (KR)

(72) Inventor: ChangHak Kang, Hwaseong-si (KR)

(21) Appl. No.: 18/789,017

(22) Filed: Jul. 30, 2024

(30) Foreign Application Priority Data
Oct. 5, 2023 (KR) 10-2023-0132490

(51) Int. Cl. B62D 25/06; B23K 11/00; B23K 101/18

(52) U.S. Cl. CPC B62D 25/06; B23K 11/008; B23K 2101/18

(57) ABSTRACT

An embodiment roof structure for a vehicle connected to roof sides of side structures disposed on both sides of an upper body of the vehicle includes a plurality of roof rails connected along a vehicle width direction on the roof sides and a roof panel assembly including a plurality of tailor welded blanks (TWB) roof panels disposed in positions corresponding to the roof rails, the roof panel assembly being connected to the roof sides and the roof rails.

### CROSS-REFERENCE TO RELATED APPLICATIONS

This application claims the benefit of Korean Patent Application No. 10-2023-0132490, filed on Oct. 5, 2023, which application is hereby incorporated herein by reference.

### TECHNICAL FIELD

The present invention relates to a vehicle body.

### BACKGROUND

Recently, the vehicle industry has been introducing a new concept of future mobility vision to realize a human-centered, dynamic future city. One of these future mobility solutions is the purpose built vehicle (PBV), which is a purpose-based mobility.

An example of a PBV is an environment-friendly mobile vehicle based on an electric vehicle (EV). These PBVs are self-driving and can provide various customized services to users during the travel time from the origin to the destination. For this purpose, PBVs are manufactured as a one box design with a large interior space.

In one example, a large-area roof panel is applied to the roof structure of the PBV to provide users with a large interior space. In another example, roof glass (or sunroof glass) is applied to the roof structure of the PBV to provide users with a sense of openness inside the interior.

The matters described in this background section are written to improve understanding of the background of embodiments of the invention, and they may include matters that are not already known.

### SUMMARY

The present invention relates to a vehicle body. Particular embodiments relate to a roof structure of a PBV.

Embodiments of the present disclosure provide a roof structure for a vehicle that can secure the connection robustness of the vehicle body and has improved performance in distributing collision load during a lateral collision of the vehicle body.

A roof structure for a vehicle connected to a roof side of a side structure disposed on both sides of an upper body according to an exemplary embodiment includes a plurality of roof rails connected along a vehicle width direction on the roof side and a roof panel assembly including a plurality of tailor welded blanks (TWB) roof panels disposed in positions corresponding to the roof rails, the roof panel assembly being connected to the roof sides and the roof rails.

A closed cross-section of a predetermined shape may be formed by the roof rails and the TWB roof panels connected together.

The roof panel assembly may include a main roof panel connected to the TWB roof panels along a front-to-back direction of the vehicle body.

A thickness of the TWB roof panels may be thicker than a thickness of the main roof panel.

The roof rails may be provided in an open form at an upper portion.

The roof rails may include junction flanges formed along the vehicle width direction at both edges.

The TWB roof panels and the junction flanges may be connected by spot welding.

A length of the TWB roof panels along the front-to-back direction of the vehicle body may be the same as a length of the roof rails along the front-to-back direction of the vehicle body.

A length of the TWB roof panels along the front-to-back direction of the vehicle body may be longer than a length of the roof rails along the front-to-back direction of the vehicle body.

The roof structure according to an exemplary embodiment of the present invention may further include a plurality of gusset members that are connected to an inner surface of the roof side and to both ends of the roof rails.

The roof structure according to an exemplary embodiment of the present invention may further include a plurality of a gusset support members that is connected to the inner surface of the roof side and to the gusset members.

According to a roof structure for a vehicle according to an exemplary embodiment, the performance of dispersing side collision loads is improved, the manufacturing process is simple, and the number of parts and weight of the vehicle body can be reduced.

In addition, the effects that can be obtained or predicted from an exemplary embodiment will be disclosed directly or implicitly in the detailed description of the embodiments of the present invention. That is, various effects expected according to embodiments of the present invention will be disclosed in the detailed description to be described later.

### BRIEF DESCRIPTION OF THE DRAWINGS

Since these drawings are intended for reference in explaining exemplary embodiments of the present invention, the technical idea of the present invention should not be interpreted as being limited to the accompanying drawings.

FIG. 1 is a perspective view showing a roof structure for a vehicle according to an exemplary embodiment.

FIG. 2 and FIG. 3 are exploded perspective views showing a roof structure for a vehicle according to an exemplary embodiment.

FIG. 4 is a drawing showing roof rails applied to a roof structure for a vehicle according to an exemplary embodiment.

FIG. 5 is a perspective view showing a mounting structure of roof rails applied to a roof structure for a vehicle according to an exemplary embodiment.

FIG. 6 is a top plan view showing a mounting structure of roof rails applied to a roof structure for a vehicle according to an exemplary embodiment.

FIG. 7 is a top plan view showing a roof panel assembly applied to a roof structure for a vehicle according to an exemplary embodiment.

FIG. 8 is a cross-sectional view along line A-A in FIG. 1.

FIG. 9 is a cross-sectional view along line B-B in FIG. 1.

FIG. 10 is a cross-sectional view along line C-C in FIG. 1.

FIG. 11A to FIG. 11C are drawings showing modified examples of a mounting structure of roof rails and a roof panel assembly applied to a vehicle roof structure according to an embodiment of the present invention.

The drawings referenced above are not necessarily drawn to scale and should be understood as presenting a rather simplified representation of various preferred features illustrating the basic principles of embodiments of the invention. The specific design features of embodiments of the invention, including, for example, specific dimensions, orientation, location, and shape, will be determined in part by the particular intended application and usage environment.

The following reference identifiers may be used in connection with the drawings to describe various features of embodiments of the present invention.

| | |
|---|---|
| 1: upper body | 3: side structure |
| 5: roof side | 7: pillar |
| 11: front roof rail | 2, 22, 32: junction flange |
| 21: rear roof rail | 31: center roof rail |
| 40: gusset member | 60: gusset support member |
| 70: roof panel assembly | 71: TWB roof panel |
| 81: main roof panel | 81a: sunroof mounting part |
| 91, 92, 93: closed cross-section | 100: roof structure for a vehicle |

### DETAILED DESCRIPTION OF ILLUSTRATIVE EMBODIMENTS

Hereinafter, with reference to the attached drawings, embodiments of the present invention will be described in detail so that those skilled in the art can easily implement the present invention. As those skilled in the art would realize, the described embodiments may be modified in various different ways, all without departing from the spirit or scope of the present invention.

The terminology used in this specification is for the purpose of describing specific exemplary embodiments, and it is not intended to limit the present invention.

As used herein, singular forms are intended to also include plural forms, unless the context clearly indicates otherwise.

The terms ‘comprising’ and/or ‘including’ as used in this specification indicate the presence of specified features, integers, steps, operations, elements and/or components, but at least one other feature, integer, step, operation, element and/or component may be present. It should also be understood that this does not exclude the presence or addition of steps, operations, components, and/or groups thereof.

As used in this specification, the term ‘and/or’ includes any one or all combinations of at least one associated listed item.

In this specification, the term ‘coupled’ or ‘connected’ means that components are directly connected to each other by welding, self piercing rivet (SPR), flow drill screw (FDS), structural adhesive, etc. or are indirectly connected through at least one intermediary component, and there is a physical relationship between two components.

The terms ‘vehicle,’ ‘of a vehicle,’ or other similar terms used in this specification are generally used in regard to passenger automobiles, including passenger vehicles, sport utility vehicles (SUVs), buses, trucks, and various commercial vehicles, and also including hybrid vehicles, electric vehicles, hybrid electric vehicles, hydrogen power vehicles, and other alternative fuel vehicles (e.g., fuels derived from resources other than petroleum).

Hereinafter, exemplary embodiments of the present invention will be described in detail with reference to the accompanying drawings.

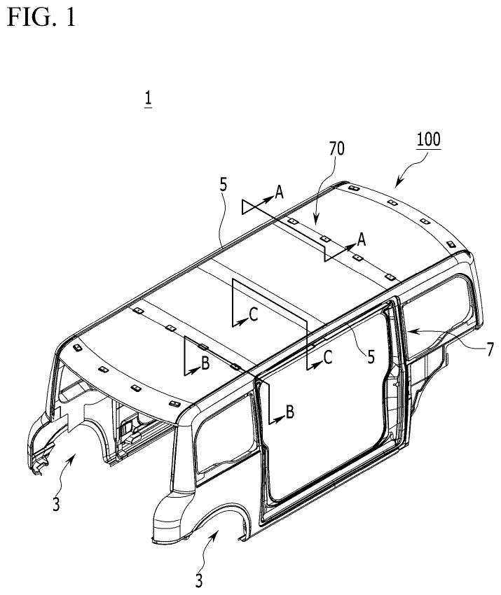

FIG. 1 is a perspective view showing a roof structure for a vehicle according to an exemplary embodiment.

Referring to FIG. 1, a roof structure 100 according to an exemplary embodiment may be applied to, for example, a vehicle body of a purpose-based mobility vehicle (purpose built vehicle: hereinafter referred to as a ‘PBV’).

In one example, the PBV may be used as an electric vehicle-based life module vehicle that provides various services to occupants while moving from one place to a destination in an unmanned self-driving manner. The life module vehicle described above is also referred to by a person of ordinary skill in the art as a ‘robo taxi,’ a ‘robo shuttle,’ or a ‘hailing vehicle.’

Such a PBV may be manufactured in a one box design with a large interior space. In addition, the PBV may apply a facing type seat to provide a wide interior space.

The body of such a PBV is suitable for small-scale production of various vehicle types with a small number of parts, and it can be manufactured in various shapes and sizes.

The vehicle body of the PBV includes a skateboard-type underbody (not shown) (commonly referred to as a ‘rolling chassis’ or ‘chassis frame’ by those skilled in the art) and an upper body 1 assembled to the underbody.

The underbody may be equipped with a battery assembly (not shown) and a drive motor (not shown). The upper body 1 is a body-in-white (BIW) body coupled to the underbody and may constitute a cabin with a wide indoor space.

In this specification, the ‘front-to-back direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

Furthermore, in this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The upper body 1 as described above includes side structures 3 disposed on both sides of the upper body 1 and the roof structure 100 connected to the upper portion of the side structures 3.

The side structure 3 includes a roof side 5 provided at an upper portion. The roof side 5 is disposed along the front-to-back direction of the vehicle body. The roof side 5 is connected with upper portion of pillars 7 provided on the side structure 3. A swing door or sliding door not shown in the drawing may be mounted on the side structure 3, and a fixed glass may be mounted on the side structure 3.

The roof structure 100 may be mounted on the roof side 5 of the side structure 3. The roof structure 100 may provide a wide interior space to occupants in a PBV with a one box design.

The roof structure 100 may further include a roof module (not shown) of functional parts such as various operation systems of the PBV and roof glass (or sunroof glass).

The roof structure 100 is provided with a structure that can secure the connection robustness of the vehicle body and has improved performance in dispersing the collision load during a side direction collision of the vehicle body.

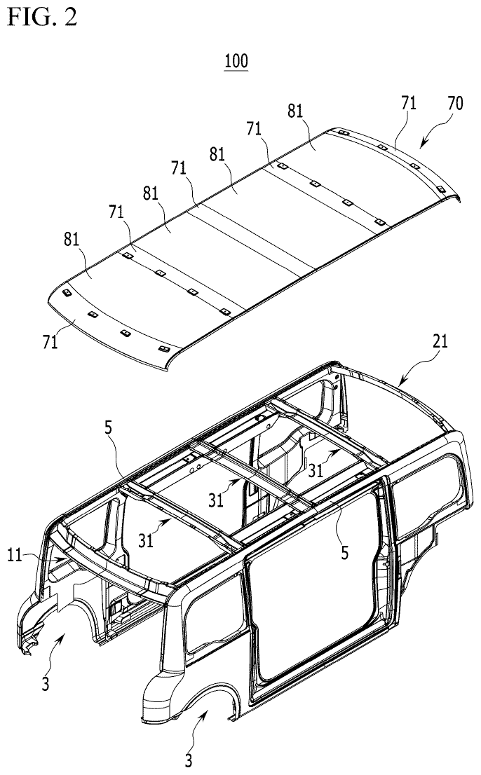

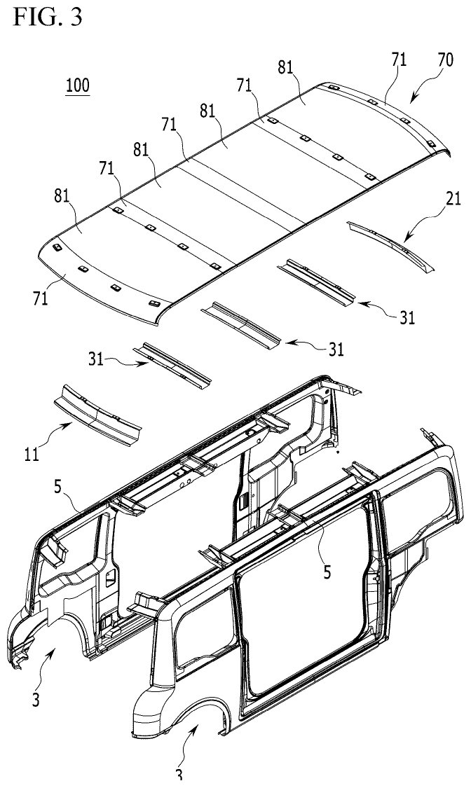

FIG. 2 and FIG. 3 are exploded perspective views showing a roof structure for a vehicle according to an exemplary embodiment.

Referring to FIG. 1 to FIG. 3, the roof structure 100 includes a plurality of roof rails 11, 21, and 31, and a roof panel assembly 70.

The roof rails 11, 21, and 31 are connected along the vehicle width direction on the roof sides 5. The roof rails 11, 21, and 31 are disposed spaced apart at predetermined intervals along the front-to-back direction of the vehicle body.

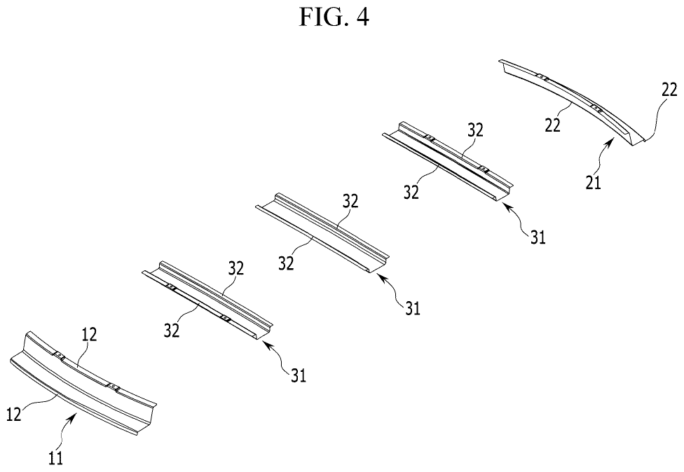

FIG. 4 is a drawing showing roof rails applied to a roof structure for a vehicle according to an exemplary embodiment.

As shown in FIG. 4, the roof rails 11, 21, and 31 may be provided with an open top.

In an exemplary embodiment, such roof rails 11, 21, and 31 include a front roof rail 11, a rear roof rail 21, and at least one center roof rail 31.

Referring to FIG. 1 to FIG. 4, the front roof rail 11 is disposed at the front of the roof sides 5. The rear roof rail 21 is disposed at the rear of the roof sides 5. And, the at least one center roof rail 31 is disposed between the front roof rail 11 and the rear roof rail 21. Here, the at least one center roof rail 31 may be provided in plural pieces (e.g., three) in one example.

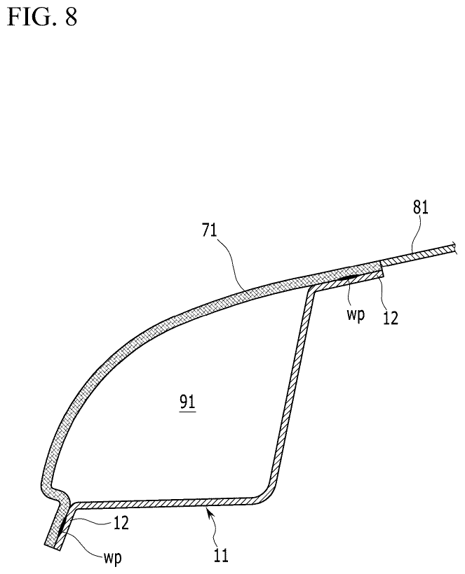

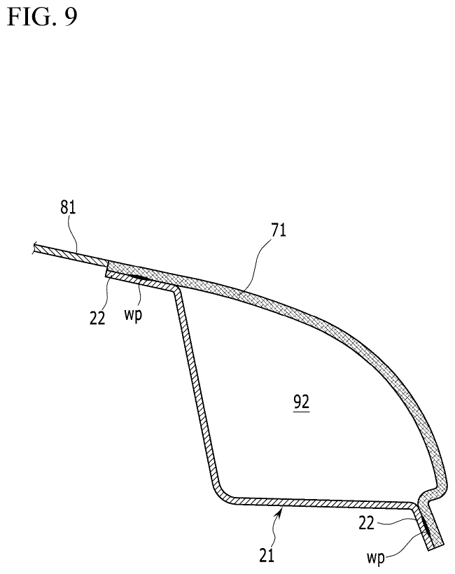

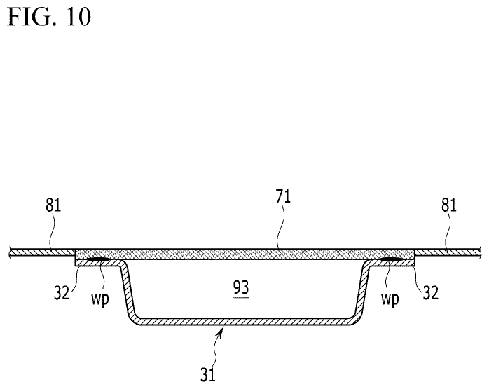

Here, the front roof rail 11 and the rear roof rail 21 may have an ‘L’ cross-section shape (see FIG. 8 and FIG. 9). And, the at least one center roof rail 31 may have a ‘U’ cross-section shape (see FIG. 10).

Furthermore, each of the front roof rail 11, the rear roof rail 21, and the at least one center roof rail 31 includes junction flanges 12, 22, and 32 formed along the vehicle width direction at both edge portions.

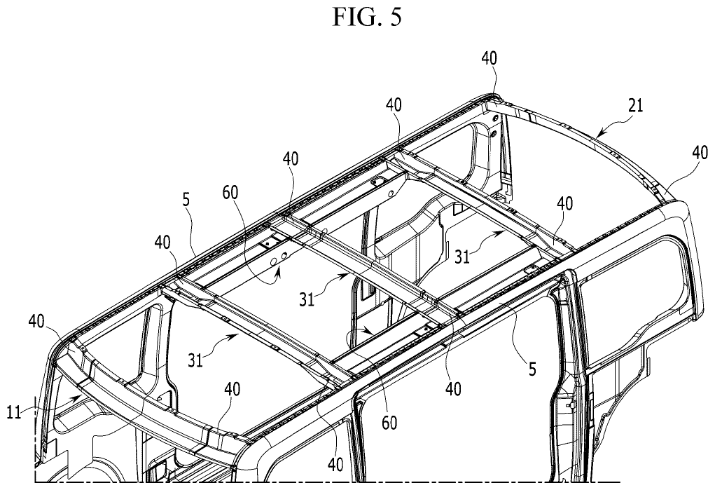

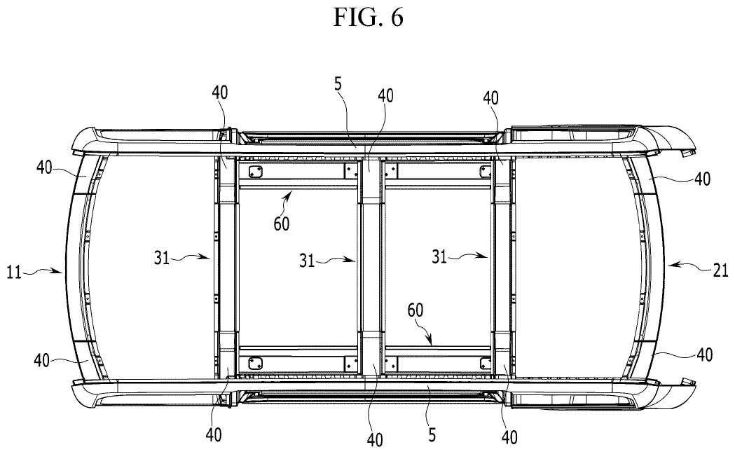

FIG. 5 is a perspective view showing a mounting structure of roof rails applied to a roof structure for a vehicle according to an exemplary embodiment, and FIG. 6 is a top plan view showing a mounting structure of roof rails applied to a roof structure for a vehicle according to an exemplary embodiment.

Referring to FIG. 5 and FIG. 6, the roof structure 100 further includes a plurality of gusset members 40 and gusset support members 60.

In an exemplary embodiment, the gusset members 40 are configured to connect the roof rails 11, 21, and 31 and the roof sides 5, to support both ends of the roof rails 11, 21, and 31, and to reinforce the mounting strength of the roof rails 11, 21, and 31.

The gusset members 40 may have the same cross-sectional shape as the roof rails 11, 21, and 31. The gusset members 40 are connected to the inner surfaces of the roof sides 5 in a direction facing each other (e.g., vehicle width direction). The gusset members 40 are connected to the inner surfaces of the roof sides 5 by welding and are connected to both ends of the roof rails 11, 21, and 31 by welding.

The gusset members 40 are connected to the front and rear of the roof side 5 and to the inner surface of the roof side 5 between the front and rear.

The gusset support member 60 is configured to support the gusset members 40 and to reinforce the strength of the roof rails 11, 21, and 31.

The gusset support member 60 is disposed along the front-to-back direction of the vehicle body on the lower side of the gusset members 40, is connected to the inner surface of the roof side 5 by welding, and is connected to the gusset members 40 by welding.

In one example, the gusset support member 60 may be connected to the gusset members 40 coupled to at least one center roof rail 31 (e.g., three center roof rails 31) of the roof rails 11, 21, and 31.

In another example, the gusset support member 60 may support roof glass or sunroof glass (not shown) when the roof glass or the sunroof glass is applied to the roof structure 100.

Referring to FIG. 1 to FIG. 3, in an exemplary embodiment, the roof panel assembly 70 is connected to the roof sides 5, the roof rails 11, 21, and 31, and the gusset members 40.

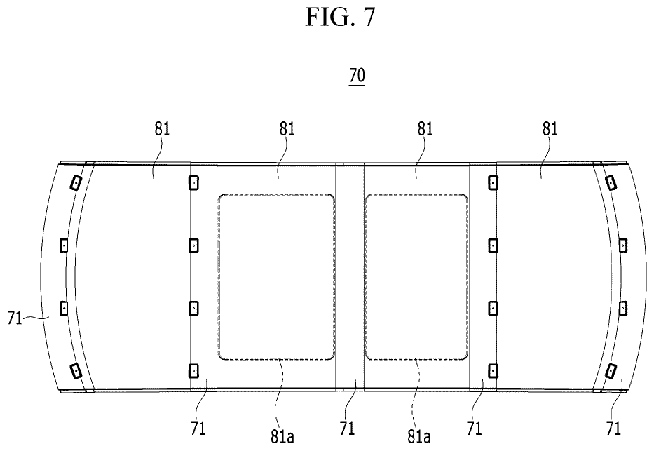

FIG. 7 is a top plan view showing a roof panel assembly applied to a roof structure for a vehicle according to an exemplary embodiment.

Referring to FIG. 2 and FIG. 7, the roof panel assembly 70 according to an exemplary embodiment includes a plurality of tailor welded blanks (TWB) roof panels 71 and a main roof panel 81.

The TWB roof panels 71 are disposed in positions corresponding to the roof rails 11, 21, and 31, and they may be connected by welding to the roof sides 5, the roof rails 11, 21, and 31, and the gusset members 40.

Each of the TWB roof panels 71 may be provided as a blank assembly in which blanks cut to a predetermined size and shape are welded together. These TWB roof panels 71 have higher strength than typical thin plate roof panels. Furthermore, each of the TWB roof panels 71 may be formed from a relatively high-strength panel in which the blank assembly is hot stamped. Since this TWB is obvious to those skilled in the art, a detailed description of its function will be omitted.

The main roof panel 81 may be formed of a typical thin plate roof panel as mentioned above. The main roof panel 81 is connected to the TWB roof panels 71 along the front-to-back direction of the vehicle body.

In one example, the main roof panel 81 may be connected to the TWB roof panels 71 by welding so that the main roof panel 81 has a skin surface that is the same as the skin surface of the TWB roof panels 71. The main roof panel 81 described above may be placed between the TWB roof panels 71.

In FIG. 7, drawing reference number 81a (indicated by a single-dot chain line) indicates a sunroof mounting part for mounting roof glass or sunroof glass (not shown).

Hereinafter, referring FIG. 8 to FIG. 10, the connection structure of the roof panel assembly 70 and the roof rails 11, 21, and 31 configured as described above will be discussed.

FIG. 8 is a cross-sectional view along line A-A in FIG. 1, FIG. 9 is a cross-sectional view along line B-B in FIG. 1, and FIG. 10 is a cross-sectional view along line C-C in FIG. 1.

Referring to FIG. 8 to FIG. 10, the TWB roof panels 71 may be joined to the junction flanges 12, 22, and 32 of the roof rails 11, 21, and 31 by spot welding.

Therefore, according to an exemplary embodiment, closed cross-sections 91, 92, and 93 of a predetermined shape may be formed by the roof rails 11, 21, and 31 and the TWB roof panels 71 combined with each other.

In the combined structure of the roof panel assembly 70 and the roof rails 11, 21, and 31 as described above, the thickness of the TWB roof panels 71 is greater than the thickness of the main roof panel 81. And, the TWB roof panels 71 have greater strength than the main roof panel 81.

In one example, the length of the TWB roof panels 71 along the front-to-back direction of the vehicle body may match the length of the roof rails 11, 21, and 31 along the front-to-back direction of the vehicle body.

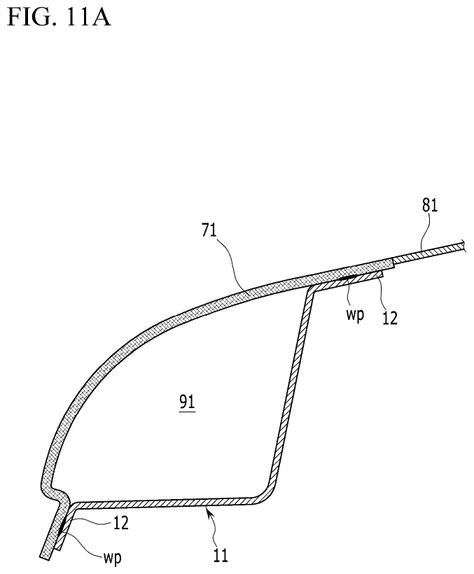

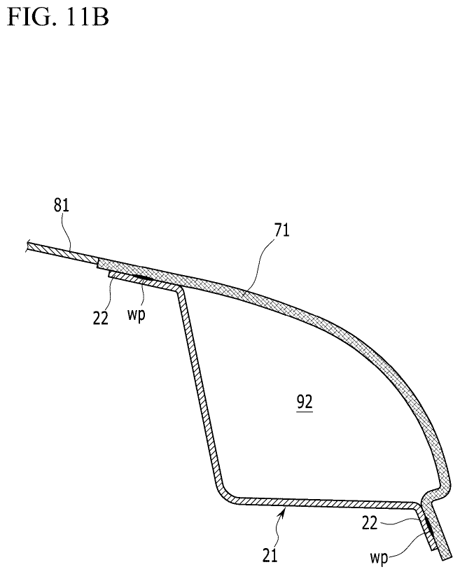

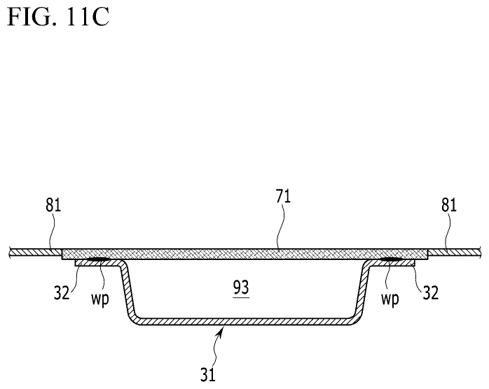

In another example, the length of the TWB roof panels 71 along the front-to-back direction of the vehicle body as shown in FIG. 11A to FIG. 11C may be longer than the length of the roof rails 11, 21, and 31 along the front-to-back direction of the vehicle body.

In the drawings, the drawing reference symbol WP indicates the spot-welding points of the junction flanges 12, 22, and 32 of the roof rails 11, 21, and 31 and the TWB roof panels 71.

Hereinafter, the assembly process and operation of the roof structure 100 as described above will be discussed referring to FIG. 1 to FIG. 11C.

In an exemplary embodiment, the gusset members 40 and the gusset support members 60 are coupled to the inner surface of the roof side 5.

The roof rails 11, 21, and 31 of predetermined shape with an open top are provided.

The roof panel assembly 70 including the TWB roof panels 71 disposed along the front-to-back direction of the vehicle body and the main roof panel 81 connected to the TWB roof panels 71 is provided.

In this state, both ends of the roof rails 11, 21, and 31 are joined to the gusset members 40 by welding (e.g., spot welding).

Then, the roof panel assembly 70 is connected to the roof sides 5, the roof rails 11, 21, and 31, and the gusset members 40.

Explaining the assembly process of the roof panel assembly 70 described above, the main roof panel 81 is joined to the roof sides 5 by spot welding.

Then, the TWB roof panels 71 are joined to the roof sides 5 and the gusset members 40 by spot welding and to the junction flanges 12, 22, and 32 of the roof rails 11, 21, and 31 by spot welding.

The roof panel assembly 70 as described above may be joined to the roof sides 5, the roof rails 11, 21, and 31, and the gusset members 40 by spot welding and structural adhesive.

Therefore, according to the roof structure 100 assembled as described above, the mounting strength of the roof rails 11, 21, and 31 can be increased by the gusset members 40 and the gusset support members 60.

According to the roof structure 100 for a vehicle according to an exemplary embodiment, as high-strength TWB roof panels 71 are applied to the roof panel assembly 70, the local strength of the entire roof panel assembly 70 can be increased.

The roof structure 100 according to an exemplary embodiment forms the high-strength closed cross-sections 91, 92, and 93 by combining the roof rails 11, 21, and 31 with open tops and the TWB roof panels 71.

According to the roof structure 100 according to an exemplary embodiment, unlike a typical structure that forms a closed cross-section by combining the lower roof rail and the upper roof rail, the manufacturing process is simple, and the number of parts and the weight of the vehicle body can be reduced.

According to the roof structure 100 according to an exemplary embodiment, the high-strength closed cross-sections 91, 92, and 93 are formed by combining the roof rails 11, 21, and 31 and the TWB roof panels 71, and thus the connection robustness and lateral strength of the body can be strengthened.

Therefore, the closed cross-sections 91, 92, and 93 form a load path along the vehicle width direction (or lateral direction) to effectively disperse the collision load through the load path when the side direction of the vehicle body collides, and the deformation of the vehicle body can be minimized.

According to the roof structure 100 according to an exemplary embodiment, roof crush performance, pole collision performance, and side collision performance can be improved.

While embodiments of this invention have been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A roof structure for a vehicle connected to roof sides of side structures disposed on both sides of an upper body of the vehicle, the roof structure comprising:
a plurality of roof rails connected along a vehicle width direction on the roof sides; and
a roof panel assembly comprising a plurality of tailor welded blanks (TWB) roof panels disposed in positions corresponding to the roof rails, the roof panel assembly being connected to the roof sides and the roof rails.

2. The roof structure of claim 1, wherein a closed cross-section of a predetermined shape is defined by the roof rails and the TWB roof panels connected together.

3. The roof structure of claim 1, wherein the roof panel assembly comprises a main roof panel connected to the TWB roof panels along a front-to-back direction of the vehicle.

4. The roof structure of claim 3, wherein a thickness of the TWB roof panels is greater than a thickness of the main roof panel.

5. The roof structure of claim 1, wherein:
the roof rails are disposed in an open form at an upper portion; and
the roof rails comprise junction flanges disposed along the vehicle width direction at both edges.

6. The roof structure of claim 5, wherein the TWB roof panels and the junction flanges are connected by spot welds.

7. The roof structure of claim 5, wherein a length of the TWB roof panels along a front-to-back direction of the vehicle is equal to a length of the roof rails along the front-to-back direction of the vehicle.

8. The roof structure of claim 5, wherein a length of the TWB roof panels along a front-to-back direction of the vehicle is greater than a length of the roof rails along the front-to-back direction of the vehicle.

9. The roof structure of claim 1, further comprising a plurality of gusset members connected to an inner surface of each of the roof sides and to both ends of the roof rails.

10. The roof structure of claim 9, further comprising a plurality of a gusset support members connected to the inner surface of each of the roof sides and to the gusset members.

11. A vehicle comprising:
an upper body comprising side structures disposed on both sides of the vehicle, wherein the side structures comprise pillars disposed in an up-and-down direction of the vehicle, and wherein roof sides of the side structures are connected to upper portions of the pillars; and
a roof structure connected to the roof sides of the side structures, the roof structure comprising:
a plurality of roof rails connected along a vehicle width direction on the roof sides; and
a roof panel assembly comprising a plurality of tailor welded blanks (TWB) roof panels disposed in positions corresponding to the roof rails, the roof panel assembly being connected to the roof sides and the roof rails.

12. The vehicle of claim 11, wherein a closed cross-section of a predetermined shape is defined by the roof rails and the TWB roof panels connected together.

13. The vehicle of claim 11, wherein the roof panel assembly further comprises a main roof panel connected to the TWB roof panels along a front-to-back direction of the vehicle.

14. The vehicle of claim 13, wherein a thickness of the TWB roof panels is greater than a thickness of the main roof panel.

15. The vehicle of claim 11, wherein:
the roof rails are disposed in an open form at an upper portion; and
the roof rails comprise junction flanges disposed along the vehicle width direction at both edges.

16. The vehicle of claim 15, wherein the TWB roof panels and the junction flanges are connected by spot welds.

17. The vehicle of claim 15, wherein a length of the TWB roof panels along a front-to-back direction of the vehicle is equal to a length of the roof rails along the front-to-back direction of the vehicle.

18. The vehicle of claim 15, wherein a length of the TWB roof panels along a front-to-back direction of the vehicle is greater than a length of the roof rails along the front-to-back direction of the vehicle.

19. The vehicle of claim 11, further comprising a plurality of gusset members connected to an inner surface of each of the roof sides and to both ends of the roof rails.

20. The vehicle of claim 19, further comprising a plurality of a gusset support members connected to the inner surface of each of the roof sides and to the gusset members.
